(19) United States
(12) Patent Application Publication
(10) Pub. No.: US 2025/0312774 A1
(43) Pub. Date: Oct. 9, 2025

(54) Surface Modification of Mixed Oxides for High PGM Dispersion

(71) Applicant: Neo Performance Materials (Singapore) Pte. Ltd., Singapore (SG)

(72) Inventors: Benedict HSU, Singapore (SG); Szu Hwee NG, Singapore (SG); Shijia LIU, Singapore (SG); Shimin BOO, Singapore (SG); Rebekah TAN, Singapore (SG); Barry HUANG, Singapore (SG)

(73) Assignee: Neo Performance Materials (Singapore) Pte. Ltd., Singapore (SG)

(21) Appl. No.: 18/860,367

(22) PCT Filed: Apr. 8, 2024
(86) PCT No.: PCT/IB2024/000179

§ 371 Date: Oct. 25, 2024

Related U.S. Application Data
(60) Provisional application No. 63/494,907, filed on Apr. 7, 2023.

(51) Int. Cl. B01J 23/63; B01J 23/10; B01J 35/30; B01J 35/53; B01J 37/02; B01J 37/04; B01J 37/08

(52) U.S. Cl. CPC B01J 23/63; B01J 23/10; B01J 35/394; B01J 35/53; B01J 37/0221; B01J 37/0228; B01J 37/04; B01J 37/088

(57) ABSTRACT

Disclosed herein are compositions having a mixed oxide core comprising cerium oxide and zirconium oxide, which is free of alumina. The mixed oxide core contains about 15 wt % to about 60 wt % cerium oxide and about 40 wt % to about 85 wt % zirconium oxide based on the total weight of the mixed oxide core. The mixed oxide core has a rare earth oxide coating, the rare earth being selected from the group consisting of cerium, lanthanum, neodymium, praseodymium, yttrium, and mixtures thereof. Further, precious metals, including palladium or rhodium, are dispersed on the surface of these composition and the compositions have higher rhodium or palladium dispersion versus a composition comprising a mixed oxide core without a rare earth oxide coating. Further disclosed are processes of producing these compositions. The compositions may be used as part of a catalyst system.

### CROSS-REFERENCE OF RELATED APPLICATIONS

This application is being filed on 8 Apr. 2024 (7 Apr. 2024 falling on a Sunday), as a PCT International application and claims priority to and the benefit of U.S. Provisional Patent Application No. 63/494,907 filed on 7 Apr. 2023, the disclosure of which is hereby incorporated by reference in its entirety.

### FIELD OF THE INVENTION

This application relates to compositions comprising a mixed oxide core of cerium oxide and zirconium oxide and optionally an additional rare earth oxide. The mixed oxide core has a rare earth oxide coating on the surface, the rare earth oxide of the coating being selected from the group consisting of cerium, lanthanum, neodymium, praseodymium, yttrium, and mixtures thereof. The composition further has rhodium or palladium on the surface, wherein the composition has a higher rhodium or palladium dispersion versus a composition without a rare earth oxide coating on the mixed oxide core.

### INTRODUCTION

Various conventional catalysts have been used for purifying exhaust gas emitted from internal combustion engines and the like. These conventional catalysts are frequently identified as three-way catalysts (TWC catalysts) and they oxidize exhaust gas pollutants, including both hydrocarbons and carbon monoxide, and reduce nitrogen oxides into relatively harmless components of water, nitrogen, and carbon dioxide. These catalysts are used under conditions of high temperature. For this reason, these catalysts need to have a high level of heat resistance such that the catalytic activity can be kept high even after a long period of time being used at these high temperatures.

These TWC catalysts typically are composed of precious metals (Pd, Pt or Rh) with alumina and rare earth oxide, coated on a flow-through monolith. However, a phenomenon of deactivation of the TWC catalysts arises due to sintering of the precious group metal (PGM) particles when subjected to the high temperatures of operating conditions. High PGM dispersion after thermal ageing is needed and is indicative of reduced sintering of the PGM particles because this preserves the active sites of the PGM to provide high catalytic performance.

To date, efforts to create a catalyst composition that remains effective under high temperature conditions for longer periods of use have not been completely successful. As such, there remains a need to develop mixed oxides to be used as catalyst that exhibit high PGM dispersion even after thermal aging.

### SUMMARY

Disclosed herein are mixed oxide compositions comprising cerium oxide and zirconium oxide with a rare earth oxide coating. The mixed oxide core with the rare earth oxide coating is also described herein as a mixed oxide with a surface modified with a rare earth oxide. These compositions have precious group metals on the surface and are free of alumina. The compositions as disclosed herein are generally mixed oxide compositions. These compositions have high precious metal dispersion. The compositions may be suitable for use in catalysis as part of a catalyst system, which may be used in gas exhaust purification.

Disclosed herein are compositions comprising a mixed oxide core comprising about 15 wt % to about 60 wt % cerium oxide and about 40 wt % to about 85 wt % zirconium oxide based on the total weight of the mixed oxide core and with the mixed oxide core and the overall composition being free of alumina. The mixed oxide core has a rare earth oxide coating on the surface, the rare earth oxide being selected from the group consisting of cerium, lanthanum, neodymium, praseodymium, yttrium, and mixtures thereof. The composition of the mixed oxide core with the rare earth oxide coating has rhodium or palladium on the surface. These compositions as disclosed herein have a higher rhodium or palladium dispersion versus a composition with a mixed oxide core not having, or without, a rare earth oxide coating.

In certain embodiments, for high palladium dispersion, the overall composition should be at least about 40% by weight for the cerium component. In other embodiments, for high rhodium dispersion, the overall composition should be at most about 25% by weight for the cerium component.

In some embodiments, the compositions have rhodium dispersed on the surface, wherein the rhodium dispersion is about 18.5% to about 28.6% after calcination (i.e., aging) at 800° C. in air for 2 hours, or about 14.3% to about 21.9% after further calcination (i.e., aging) at 1000° C. in air for 10 hours, or about 10.3% to about 16.5% after further calcination (i.e., aging) at 1100° C. in air for 10 hours.

In other embodiments, the compositions have palladium dispersed on the surface, wherein the palladium dispersion is about 35.0% to about 46.1% after calcination (i.e., aging) at 800° C. in air for 2 hours, or about 8.5% to about 13.0% after calcination (i.e., aging) at 1000° C. in air for 10 hours, or about 3.9% to about 6.0% after calcination (i.e., aging) at 1100° C. in air for 10 hours.

In certain embodiments, the composition comprises a mixed oxide core consisting essentially of cerium oxide, zirconium oxide, and additional rare earth oxide selected from the group consisting of lanthanum oxide, neodymium oxide, praseodymium oxide, yttrium oxide, and mixtures thereof. The rare earth oxide coating is one or two of cerium oxide, neodymium oxide, and praseodymium oxide. The composition has rhodium or palladium on the surface. When palladium, the palladium dispersion is about 35.0% to about 46.1% after calcination at 800° C. in air for 2 hours, or about 8.5% to about 13% after calcination at 1000° C. in air for 10 hours, or about 3.9% to about 6.0% after calcination at 1100° C. in air for 10 hours. Or when rhodium, the rhodium dispersion is about 18.5% to about 28.6% after calcination at 800° C. in air for 2 hours, or about 14.3% to about 21.9% after calcination at 1000° C. in air for 10 hours, or about 10.3% to about 16.5% after calcination at 1100° C. in air for 10 hours.

Also disclosed herein is a process of producing a composition comprising a mixed oxide core with a rare earth coating oxide coating on the surface, wherein the composition has rhodium or palladium on the surface. The process comprises the steps of: (a) providing mixed oxide powders of cerium oxide, zirconium oxide, and optionally one or more of rare earth oxides selected from the group consisting of neodymium, lanthanum, praseodymium, and yttrium; (b) dissolving a rare earth salt in water wherein the rare earth of the salt is selected from the group consisting of cerium, lanthanum, neodymium, praseodymium, yttrium, and mixtures thereof to provide a rare earth solution; (c) combining the rare earth solution with the mixed oxide powders and mixing to provide a homogeneous powder mixture; (d) calcining the homogeneous powder mixture at approximately 400-600° C., and preferably 500° C., for approximately 2-5, and preferably 3 hours, hours to provide a mixed oxide core with a rare earth oxide coating on the surface, wherein the rare earth of the coating is selected from the group consisting of cerium, lanthanum, neodymium, praseodymium, yttrium, and mixtures thereof; (c) adding a rhodium or palladium salt solution to the mixed oxide core with a rare earth oxide coating; and (f) calcining at about 500° C. to about 650° C., and preferably 550° C., for about 2 hours to about 5 hours, and preferably 2 hours, to provide an oxide composition comprising a mixed oxide core having a rare earth oxide coating on the surface and having higher rhodium or palladium dispersion versus a composition with mixed oxide core not having or without a rare earth oxide coating.

In one embodiment, the calcining of step (d), the “first calcination”, is at a temperature of about 500° C. for approximately 3 hours. In one embodiment, the calcining of step (f), the “second calcination”, is at a temperature of about 550° C. for about 2 hours.

### BRIEF DESCRIPTION OF THE DRAWINGS

FIG. 1 illustrates a flowchart of an embodiment of the process of making the compositions as disclosed herein.

### DETAILED DESCRIPTION

This disclosure generally relates to compositions of a mixed oxide core comprising cerium oxide, zirconium oxide, and optionally an additional rare earth oxide. The mixed oxide core and the overall composition is free of alumina. The mixed oxide core has a rare earth oxide coating on the surface, the rare earth oxide being selected from the group consisting of cerium, lanthanum, neodymium, praseodymium, yttrium, and mixtures thereof. These compositions generally are mixed oxide compositions and have higher previous metal dispersion, and in particular higher rhodium or palladium dispersion. The mixed oxide core with the rare earth oxide coating is also described herein as a mixed oxide with surface modification, the surface modification being an additional rare earth oxide coating.

The composition of the mixed oxide core with the rare earth oxide coating has a precious group metal on the surface, and in some embodiments, this precious group metal is rhodium or palladium. These compositions as disclosed herein have a higher precious group metal dispersion versus a composition with mixed oxide core not having or without a rare earth oxide coating. In certain embodiments, the compositions as disclosed herein have a higher rhodium or palladium dispersion versus a composition with mixed oxide core not having or without a rare earth oxide coating. For this comparison the mixed oxide core is compositionally identical but for the rare earth oxide coating.

Before the compositions comprising zirconium oxide and cerium oxide and being free of alumina, and processes for making the same are disclosed and described, it is to be understood that this disclosure is not limited to the particular structures, process steps, or materials disclosed herein, but is extended to equivalents thereof as would be recognized by those ordinarily skilled in the relevant arts. It should also be understood that terminology employed herein is used for the purpose of describing particular embodiments only and is not intended to be limiting. It must be noted that, as used in this specification, the singular forms “a,” “an,” and “the” include plural referents unless the context clearly dictates otherwise. Thus, for example, reference to “a step” may include multiple steps, reference to “producing” or “products” of a reaction or treatment should not be taken to be all of the products of a reaction/treatment, and reference to “treating” may include reference to one or more of such treatment steps. As such, the step of treating can include multiple or repeated treatment of similar materials/streams to produce identified treatment products.

Numerical values with “about” or “approximately” include typical experimental variances and these terms “about” and “approximately” are used interchangeably. As used herein, the term “about” or “approximately” means within a statistically meaningful range of a value, such as a stated particle size, concentration range, time frame, molecular weight, temperature, or pH. Such a range can be within an order of magnitude, typically within 10%, and more typically within 5% of the indicated value or range. Sometimes, such a range can be within the experimental error typical of standard methods used for the measurement and/or determination of a given value or range. The allowable variation encompassed by the term “about” will depend upon the particular system under study, and can be readily appreciated by one of ordinary skill in the art. Whenever a range is recited within this application, every whole number integer within the range is also contemplated as an embodiment of the invention.

Based on the total weight of the composition and based on the overall composition are used interchangeably and are in contrast to based on the total weight of the mixed oxide core. Surface modification with a rare earth oxide is also used herein interchangeably with a rare earth oxide coating.

The present application relates to oxide compositions. These compositions have a mixed oxide core, wherein the mixed oxide core has a rare earth coating on its surface. The mixed oxide core contains about 15 wt % to about 60 wt % cerium oxide and about 40 wt % to about 85 wt % zirconium oxide based on the total weight of the mixed oxide core and being free of alumina. In fact, the compositions as disclosed herein in their entirety are free of alumina.

Free of alumina means that the composition contains less than about 0.1% by weight to about zero % by weight alumina. In some embodiments, free of alumina means no detectable amount of alumina or about zero % by weight alumina. In all embodiments of the composition as disclosed herein both the mixed oxide core and the overall composition are free of alumina as defined above.

In addition to zirconium oxide and cerium oxide, the mixed oxide core optionally may also contain one or more rare earth oxides other than cerium. These additional and optional rare earths oxides include oxides of any of the rare earth elements other than cerium. In particular embodiments, the additional one or more rare earth oxides of the mixed oxide core are lanthanum oxide, neodymium oxide, praseodymium oxide, and yttrium oxide. As such, the mixed oxide core optionally also may contain one or more of lanthanum oxide, neodymium oxide, praseodymium oxide, and yttrium oxide. Accordingly, the compositions as disclosed herein comprise a mixed oxide core comprising zirconium oxide and cerium oxide, and optionally additional rare earth oxide selected from the group consisting of yttrium oxide, lanthanum oxide, neodymium oxide, praseodymium oxide, and mixtures thereof.

In certain embodiments, the mixed oxide core contains two of these additional oxides. In other embodiments, the mixed oxide core contains three of these additional oxides. In certain embodiments, the composition comprises a mixed oxide core consisting essentially of cerium oxide, zirconium oxide and additional rare earth oxide selected from the group consisting of lanthanum oxide, neodymium oxide, praseodymium oxide, yttrium oxide, and mixtures thereof.

As described, the mixed oxide core has a rare earth oxide coating on its surface. This is also described as a mixed oxide with its surface modified with a rare earth oxide. The rare earth of the rare earth oxide coating is selected from the group consisting of cerium, lanthanum, neodymium, praseodymium, yttrium, and mixtures thereof. In certain embodiments, the rare earth oxide coating on the surface is one or two of cerium oxide, neodymium oxide, and praseodymium oxide. The rare earth oxide coating may be in an amount of about 1 wt % to about 10 wt % based on the total weight of the composition. In certain embodiments, the rare earth oxide coating may be in an amount of about 1 wt % to about 8 wt % based on the total weight of the composition. In specification embodiments, the rare earth oxide coating may be in an amount of about 1 wt % to about 6 wt % based on the total weight of the composition.

The mixed oxide core contains about 15 wt % to about 60 wt % cerium oxide and about 40 wt % to about 85 wt % zirconium oxide based on the total weight of the mixed oxide core and being free of alumina. In terms of the overall composition, the composition contains about 15 wt % to about 60 wt % cerium oxide and about 40 wt % to about 85 wt % zirconium oxide based on the total weight of the composition and the overall composition being free of alumina.

In embodiments wherein the mixed oxide core contains an additional rare earth oxide, the one or more additional rare earth oxides may be present in an amount of about 2 wt % to about 15 wt % based on the total weight of the composition. In certain embodiments, the one or more additional rare earth oxides may be present in an amount of about 5 wt % to about 12 wt % based on the total weight of the composition. In particular embodiments, the one or more additional rare earth oxides may be present in an amount of about 7 wt % to about 10 wt % based on the total weight of the composition.

In certain embodiments, the composition has a mixed oxide core comprising CeO₂ and ZrO₂ and one or more of La₂O₃, Y₂O₃, Nd₂O₃, and Pr₆O₁₁, wherein this mixed oxide core has a rare earth oxide coating on its surface and the rare earth of the rare earth oxide coating is one or two of CeO₂, Nd₂O₃, and Pr₆O₁₁. In certain of these compositions, the composition has rhodium on its surface and in other embodiments, the composition has palladium on its surface.

In the compositions as disclosed herein, the rare earth coating is about 1 wt % to about 10 wt % based on the total weight of the composition. In certain embodiments, the rare earth oxide coating is a single rare earth oxide, with the rare earth of this single rare earth oxide being selected from the group consisting of cerium, lanthanum, neodymium, and praseodymium, and the rare earth oxide coating is about 1 wt % to about 5 wt % based on the total weight of the composition. In other embodiments, the rare earth oxide coating is two rare earth oxides, with the two rare earths of the rare earth oxide coating being independently selected from the group consisting of cerium, lanthanum, neodymium, and praseodymium, and each rare earth oxide of the coating is about 1 wt % to about 5 wt % based on the total weight of the composition (so that the total rare earth oxide coating is about 2 wt % to about 10 wt % based on the total weight of the composition).

The composition further has precious metals on the surface. These precious metals may be any precious group metal including platinum, palladium, and rhodium. In specific embodiments, the composition has palladium or rhodium dispersed on the surface. As disclosed and described herein, the composition has a higher precious group metal dispersion versus a composition with mixed oxide core without (i.e., not having) a rare earth oxide coating. In specific embodiments, the composition has a higher rhodium or palladium dispersion versus a composition with mixed oxide core without (i.e., not having) a rare earth oxide coating. The present combination of the mixed oxide core and a rare earth oxide coating provides an improved composition, with higher precious metal dispersion, and in some embodiments, higher rhodium or palladium dispersion. As such, the oxide compositions as disclosed herein are better suited for uses as catalysts or in catalyst compositions.

In certain embodiments, the precious metals are palladium and in other embodiments, the precious metals are rhodium. The precious metals may be on the surface as metallics or as oxides. In certain embodiments, the composition comprises rhodium and the rhodium is present as oxides and the overall composition comprises about 0.3 wt % Rh₂O₃ to about 0.8 wt % Rh₂O₃ based on the total weight of the compositions, and in particular embodiments, about 0.5 wt % Rh₂O₃ based on the total weight of the composition. In other embodiments, the composition comprises palladium and the palladium is present as oxides and the overall composition comprises 1.0 wt % PdO to 2.0 wt % PdO based on the total weight of the composition, and in particular embodiments, about 1.6 wt % PdO based on the total weight of the composition.

For high palladium dispersion, the overall composition should be at least about 40% by weight for the cerium component. For high rhodium dispersion, the overall composition should be at most about 25% by weight for the cerium component.

In certain embodiments with palladium, the composition comprises a mixed oxide core wherein the mixed oxide core comprises about 35 wt % to about 60 wt % cerium oxide based on the weight of the mixed oxide core, about 40 wt % to about 65 wt % zirconium oxide based on the weight of the mixed oxide core, and one or more of lanthanum oxide, neodymium oxide, praseodymium oxide, and yttrium oxide. The mixed oxide core has a rare earth oxide coating, wherein the rare earth of the rare earth oxide coating is selected from the group consisting of cerium, lanthanum, neodymium, praseodymium, yttrium, and mixtures thereof. In certain of these embodiments, the mixed oxide core additionally contains lanthanum oxide, neodymium oxide, and praseodymium oxide. In other of these embodiments, the mixed oxide core additionally contains lanthanum oxide, neodymium oxide, and yttrium oxide. In certain of these embodiments, the rare earth oxide coating is neodymium oxide, cerium oxide, praseodymium oxide, or a mixture thereof. This composition has higher palladium dispersion versus a composition with a mixed oxide core without or not having a rare earth oxide coating. For this comparison, the mixed oxide core is compositionally identical but for the rare earth oxide coating.

In other embodiments with palladium, the composition comprises a mixed oxide core comprising about 35 wt % to about 60 wt % cerium oxide based on the total weight of the mixed oxide core; about 40 wt % to about 65 wt % zirconium oxide based on the total weight of the mixed oxide core; optionally one or more of lanthanum oxide, neodymium oxide, praseodymium oxide, and yttrium oxide, and being free of alumina. The mixed oxide core has a rare earth oxide coating, the rare earth of the rare earth oxide coating being selected from the group consisting of cerium, lanthanum, neodymium, praseodymium, yttrium, and mixtures thereof. The composition has palladium dispersed on the surface, wherein the palladium dispersion is about 35.0% to about 46.1% after calcination at 800° C. in air for 2 hours, or about 8.5% to about 13.0% after calcination at 1000° C. in air for 10 hours, or about 3.9% to about 6.0% after calcination at 1100° C. in air for 10 hours.

In certain embodiments with rhodium, the composition comprises a mixed oxide core wherein the mixed oxide core comprises about 15 wt % to about 25 wt % cerium oxide based on the weight of the mixed oxide core, about 70 wt % to about 85 wt % zirconium oxide based on the weight of the mixed oxide core, and one or more of lanthanum oxide, neodymium oxide, praseodymium oxide, and yttrium oxide. The mixed oxide core has a rare earth oxide coating, wherein the rare earth of the rare earth oxide coating is selected from the group consisting of cerium, lanthanum, neodymium, praseodymium, yttrium, and mixtures thereof. In certain of these embodiments, the mixed oxide core additionally contains lanthanum oxide and neodymium oxide. In certain of these embodiments, the rare earth oxide coating is neodymium oxide, cerium oxide, or a mixture thereof. This composition has higher rhodium dispersion versus a composition with a mixed oxide core without or not having a rare earth oxide coating. For this comparison, the mixed oxide core is compositionally identical but for the rare earth oxide coating.

In other embodiments with rhodium, the composition comprises a mixed oxide core comprising about 15 wt % to about 25 wt % cerium oxide based on the total weight of the mixed oxide core; about 70 wt % to about 85 wt % zirconium oxide based on the total weight of the mixed oxide core; optionally one or more of lanthanum oxide, neodymium oxide, praseodymium oxide, and yttrium oxide; and being free of alumina. The mixed oxide core has a rare earth oxide coating, the rare earth of the rare earth oxide coating being selected from the group consisting of cerium, lanthanum, neodymium, praseodymium, yttrium, and mixtures thereof. The composition has rhodium dispersed on the surface, wherein the rhodium dispersion is about 18.5% to about 28.6% after calcination at 800° C. in air for 2 hours, or about 14.3% to about 21.9% after calcination at 1000° C. in air for 10 hours, or about 10.3% to about 16.5% after calcination at 1100° C. in air for 10 hours.

The compositions as disclosed herein may contain trace amounts of impurities. These impurities are typically present in an amount of about 1% by weight or less (to about zero or to an amount that is undetectable) based on the total weight of the composition. These impurities include residual solvents, salts, other metals, and the like. These other metals include those commonly found in water, such as magnesium, iron, calcium, silicon, sodium, and the like. These impurity amounts (of about 1% by weight to about zero or to an amount that is undetectable) may be present in any of the described embodiments of the compositions as disclosed herein. When present and detectable, any impurities may be present in an amount of about 100 ppm or less.

### Measurement of Rhodium Dispersion:

Rhodium dispersion was determined from the CO adsorption amount measured using a CO pulse chemisorption method. The characterization was performed on the aged powder in a Micrometrics Autochem 2920 system. About 0.5 g of the rhodium-loaded sample was weighed into a quartz sample tube with a packed quartz wool bed. Each sample was then reduced to 900° C. for 30 min under 50 cm³/min flow of 10% H₂/Ar. Subsequently, He was flowed at 50 cm³/min for 30 min. Sample was then cooled to 35° C. under 50 cm³/min He flow. 10% CO/He was pulsed into the sample every 2 min until saturation is reached. A stoichiometric ratio of 1:1 CO:Rhodium atom is assumed. The sample mass after analysis is used to quantify rhodium dispersion percentage.

In certain embodiments, the composition comprises a mixed oxide core comprising about 15 wt % to about 25 wt % cerium oxide, about 70 wt % to about 85 wt % zirconium oxide, and one or more of lanthanum oxide, neodymium oxide, praseodymium oxide, and yttrium oxide, and being free of alumina. The mixed oxide core has a rare earth coating. The rare earth of the rare earth oxide coating is selected from neodymium, cerium, praseodymium, or mixtures thereof. This composition is free of alumina. The composition has a higher rhodium dispersion versus a composition with a mixed oxide core without or not having a rare earth oxide coating.

In specific embodiments, the composition comprises a mixed oxide core consisting essentially of cerium oxide, zirconium oxide, lanthanum oxide, and neodymium oxide, and the rare earth coating is one or both of cerium oxide and neodymium oxide. This composition is free of alumina and has a higher rhodium dispersion versus a composition with a mixed oxide core without or not having a rare earth oxide coating.

In additional embodiments with rhodium on the surface of the composition, the composition comprises about 20 wt % to about 25 wt % cerium oxide based on the total weight of the composition and about 1 wt % to about 10 wt % rare earth oxide coating based on the total weight of the composition.

In particular embodiments, the composition comprises a mixed oxide core comprising about 15 wt % to about 25 wt % cerium oxide, about 70 wt % to about 85 wt % zirconium oxide based on the total weight of the mixed oxide core, and optionally one or more of lanthanum oxide, neodymium oxide, praseodymium oxide, and yttrium oxide, and being free of alumina. The mixed oxide core has a rare earth oxide coating with the rare earth of the rare earth oxide coating selected from the group consisting of cerium, lanthanum, neodymium, praseodymium, yttrium, and mixtures thereof. The composition further has rhodium dispersed on the surface, wherein the rhodium dispersion is about 18.5% to about 28.6% after calcination (aging) at 800° C. in air for 2 hours, or about 14.3% to about 21.9% after calcination (aging) at 1000° C. in air for 10 hours, or about 10.3% to about 16.5% after calcination (aging) at 1100° C. in air for 10 hours. These further calcinations (or agings) are aging treatments performed after the compositions are prepared. These further calcinations (or agings) may be performed independently.

In certain embodiments, the composition comprises about 20 wt % to about 25 wt % cerium oxide based on the total weight of the composition and about 1 wt % to about 10 wt % rare earth oxide coating based on the total weight of the composition and has rhodium dispersed on the surface. In these embodiments, the composition has a higher rhodium dispersion versus a composition having a mixed oxide core without or not having a rare earth oxide coating. The rhodium dispersion can be about 18.5% to about 28.6% after calcination (aging) at 800° C. in air for 2 hours, or about 14.3% to about 21.9% after calcination (aging) at 1000° C. in air for 10 hours, or about 10.3% to about 16.5% after calcination (aging) at 1100° C. in air for 10 hours. These further calcinations (or agings) are aging treatments performed after the compositions are prepared. These further calcinations (or agings) may be performed independently.

In certain embodiments, the rhodium dispersion may be about 21% after calcination (aging) at 800° C. in air for 2 hours, about 15% after calcination (aging) at 1000° C. in air for 10 hours, or about 10.5% after calcination (aging) at 1100° C. in air for 10 hours.

The % of rhodium dispersion does not refer to the percentage of the surface that is covered by the rhodium. Instead, it refers to the percentage of rhodium atoms that exists as surface atoms. For example, a theoretical 100% rhodium dispersion means all rhodium atoms (that are added into the composition) exist as rhodium surface atoms. Typically, this parameter is used to quantify the degree of sintering of rhodium particles after calcination (aging).

As described herein, the calcination (aging) conditions are not cumulative. The rhodium dispersion values are achieved after calcining (aging) the composition comprising a mixed oxide core having a rare earth oxide coating with the rhodium on its surface has been prepared. During its preparation, the composition is thermally treated or calcined before the rhodium is added and a second calcining or thermally treating is performed after the rhodium is added. This process provides the “fresh” or “as prepared” composition. The thermally treating or calcining during preparation of the composition after the rhodium is added is conducted at about 500° C. to about 650° C. (preferably 550° C.) about for about 2 to 5 hours (preferably at about 2 hours). The aging calcinations to test the degree of sintering of rhodium particles are performed under the different conditions specified herein independently. These further calcining or aging treatments may be performed at about 800° C. in air for about 2 hours, at about 1000° C. in air for about 10 hours, or at about 1100° C. in air for about 10 hours and are utilized to test the rhodium sintering during simulated use.

### Measurement of Palladium Dispersion:

The palladium dispersion was determined from the CO adsorption amount measured using a CO pulse chemisorption method. The characterization was performed on the aged powder in a Micrometrics Autochem 2920 system. About 0.5 g of the Pd-loaded sample was weighed into a quartz sample tube with a packed quartz wool bed. Each sample was then reduced to 400° C. for 30 min under 50 cm³/min flow of 10% H₂/Ar. Subsequently, He was flowed at 50 cm³/min for 30 min. Sample was then cooled to 35° C. under 50 cm³/min He flow. 10% CO/He was pulsed into the sample every 2 min until saturation is reached. A stoichiometric ratio of 1:1 CO:Palladium atom is assumed. Sample mass after analysis is used to quantify palladium dispersion percentage.

In certain embodiments, the composition comprises a mixed oxide core comprising about 35 wt % to about 60 wt % cerium oxide, about 40 wt % to about 65 wt % zirconium oxide, and one or more of lanthanum oxide, neodymium oxide, praseodymium oxide, and yttrium oxide, and being free of alumina. The mixed oxide core has a rare earth coating. The rare earth of the rare earth oxide coating is selected from neodymium, cerium, praseodymium, or mixtures thereof. The composition has a higher palladium dispersion versus a composition with a mixed oxide core without, or not having, a rare earth oxide coating.

In specific embodiments, the composition comprises a mixed oxide core consisting essentially of cerium oxide, zirconium oxide, and two or more of lanthanum oxide, neodymium oxide, praseodymium oxide, and yttrium oxide, and the rare earth coating is cerium oxide, neodymium oxide, or praseodymium oxide. This composition is free of alumina and has a higher rhodium dispersion versus a composition with a mixed oxide core without or not having a rare earth oxide coating.

In additional embodiments with palladium on the surface of the composition, the composition comprises about 40 wt % to about 60 wt % cerium oxide based on the total weight of the composition and about 1 wt % to about 10 wt % rare earth oxide coating based on the total weight of the composition.

In particular embodiments, the composition comprises a mixed oxide core comprising about 35 wt % to about 60 wt % cerium oxide based on the total weight of the mixed oxide core; about 40 wt % to about 65 wt % zirconium oxide based on the total weight of the mixed oxide core; optionally one or more of lanthanum oxide, neodymium oxide, praseodymium oxide, and yttrium oxide, and being free of alumina. The mixed oxide core has a rare earth oxide coating, the rare earth of the rare earth oxide coating being selected from the group consisting of cerium, lanthanum, neodymium, praseodymium, yttrium, and mixtures thereof. The composition has palladium dispersed on the surface, wherein the palladium dispersion is about 35.0% to about 46.1% after calcination at 800° C. in air for 2 hours, or about 8.5% to about 13.0% after calcination at 1000° C. in air for 10 hours, or about 3.9% to about 6.0% after calcination at 1100° C. in air for 10 hours.

In specific embodiments, the composition comprises a mixed oxide core consisting essentially of cerium oxide, zirconium oxide, lanthanum oxide, neodymium oxide, and praseodymium oxide, and the rare earth coating is cerium oxide, neodymium oxide, or praseodymium oxide. This composition is free of alumina and has a higher palladium dispersion versus a composition with a mixed oxide core without, or not having, a rare earth oxide coating.

In other specific embodiments, the composition comprises a mixed oxide core consisting essentially of cerium oxide, zirconium oxide, lanthanum oxide, neodymium oxide, and yttrium oxide, and the rare earth coating is cerium oxide or neodymium oxide. This composition is free of alumina and has a higher palladium dispersion versus a composition with a mixed oxide core without, or not having, a rare earth oxide coating.

In further specific embodiments, the composition comprises a mixed oxide core consisting essentially of cerium oxide, zirconium oxide, lanthanum oxide, and yttrium oxide, and the rare earth coating is cerium oxide or neodymium oxide. This composition is free of alumina and has a higher palladium dispersion versus a composition with a mixed oxide core without, or not having, a rare earth oxide coating.

In certain embodiments, the composition comprises a mixed oxide core comprising about 35 wt % to about 60 wt % cerium oxide, about 40 wt % to about 65 wt % zirconium oxide based on the total weight of the mixed oxide core, and optionally one or more of lanthanum oxide, neodymium oxide, praseodymium oxide, and yttrium oxide, and being free of alumina. The mixed oxide core has a rare earth oxide coating with the rare earth of the rare earth oxide coating selected from the group consisting of cerium, lanthanum, neodymium, praseodymium, yttrium, and mixtures thereof on the surface. The composition further has palladium dispersed on the surface, wherein the palladium dispersion is about 35.0% to about 46.1% after calcination (aging) at 800° C. in air for 2 hours, or about 8.5% to about 13.0% after calcination (aging) at 1000° C. in air for 10 hours, or about 3.9% to about 6.0% after calcination (aging) at 1100° C. in air for 10 hours. These further calcinations (or agings) are aging treatments performed after the compositions are prepared. These further calcinations (or agings) may be performed independently.

In certain embodiments, the composition comprises about 40 wt % to about 60 wt % cerium oxide based on the total weight of the composition and about 1 wt % to about 10 wt % rare earth oxide coating based on the total weight of the composition and has palladium dispersed on the surface. In these embodiments, the composition has a higher palladium dispersion versus a composition having a mixed oxide core without, or not having, a rare earth oxide coating. The palladium dispersion can be about 35.0% to about 46.1% after calcination (aging) at 800° C. in air for 2 hours, or about 8.5% to about 13.0% after calcination (aging) at 1000° C. in air for 10 hours, or about 3.9% to about 6.0% after calcination (aging) at 1100° C. in air for 10 hours. These further calcinations (or agings) are aging treatments performed after the compositions are prepared. These further calcinations (or agings) may be performed independently.

In some embodiments, the palladium dispersion can be about 35.0% to about 46.1% after calcination (aging) at 800° C. in air for 2 hours, or about 8.5% to about 12.3% after calcination (aging) at 1000° C. in air for 10 hours, or about 3.9% to about 5.8% after calcination (aging) at 1100° C. in air for 10 hours.

In certain embodiments, the palladium dispersion may be about 40% after calcination (aging) at 800° C. in air for 2 hours, about 10.0% after calcination (aging) at 1000° C. in air for 10 hours, or about 4% after calcination (aging) at 1100° C. in air for 10 hours.

The % of palladium dispersion does not refer to the percentage of the surface that is covered by the palladium. Instead, it refers to the percentage of palladium atoms that exists as surface atoms. For example, a theoretical 100% palladium dispersion means all palladium atoms (that are added into the composition) exist as palladium surface atoms. Typically, this parameter is used to quantify the degree of sintering of palladium particles after calcination (aging).

As described herein, the calcination (aging) conditions are not cumulative. The palladium dispersion values are achieved after calcining (aging) the mixed composition comprising a mixed oxide core having a rare earth oxide coating with palladium on its surface has been prepared. During its preparation, the composition is thermally treated or calcined before the palladium is added and a second calcining or thermally treating is performed after the palladium is added. This process provides the “fresh” or “as prepared” composition. The thermally treating or calcining during preparation of the composition after the palladium is added is conducted at about 500° C. to about 650° C. (preferably 550° C.) about for about 2 to 5 hours (preferably at about 2 hours). The aging calcinations to test the degree of sintering of palladium particles are performed under the different conditions specified herein independently. These further calcining or aging treatments may be performed at about 800° C. in air for about 2 hours, at about 1000° C. in air for about 10 hours, or at about 1100° C. in air for about 10 hours and are utilized to test the palladium sintering during simulated use.

In particular embodiments, with rhodium dispersion, the composition, including the mixed oxide core and the rare earth coating, contains zirconium oxide, cerium oxide, lanthanum oxide, and neodymium oxide. In these embodiments, the mixed oxide core may contain zirconium oxide, cerium oxide, lanthanum oxide, and neodymium oxide and the rare earth of the rare earth oxide coating may be cerium, neodymium, or a mixture thereof. In this embodiment, the mixed oxide core of the composition may have a ratio of Ce/Zr/La/Nd of approximately 18.5 wt % to approximately 21.5 wt % Ce, approximately 74 wt % to approximately 77 wt % Zr, approximately 1.5 wt % to approximately 2.0 wt % La, and approximately 2.0 wt % to approximately 2.5 wt % Nd, on an equivalent oxide basis, and the rare earth oxide coating consists essentially of one or both of CeO₂ and Nd₂O₃. In certain of these embodiments, the rare earth oxide coating is about 3 wt % to about 6 wt % based on the total weight of the composition.

In particular embodiments with palladium dispersion, the composition, including the mixed oxide core and the rare earth coating, contains zirconium oxide, cerium oxide, lanthanum oxide, neodymium oxide, and praseodymium oxide. In these embodiments, the mixed oxide core may contain zirconium oxide, cerium oxide, lanthanum oxide, neodymium oxide, and praseodymium oxide and the rare earth of the rare earth oxide coating may be cerium, neodymium, or praseodymium. In this embodiment, the mixed oxide core of the composition may have a ratio of Ce/Zr/La/Nd/Pr of approximately 36.5 wt % to approximately 41.5 wt % Ce, approximately 50 wt % to approximately 53 wt % Zr, approximately 2 wt % to approximately 2.2 wt % La, approximately 1 wt % to approximately 4.3 wt % Nd, and approximately 1 wt % to approximately 4.3 wt % Pr, on an equivalent oxide basis, and the rare earth oxide coating consists essentially of one or two of CeO₂, Nd₂O₃, and Pr₆O₁₁. In certain of these embodiments, the rare earth oxide coating is about 1 wt % to about 6 wt % based on the total weight of the composition.

In particular embodiments with palladium dispersion, the composition, including the mixed oxide core and the rare earth coating, contains zirconium oxide, cerium oxide, lanthanum oxide, yttrium oxide, and optionally neodymium oxide. In these embodiments, the mixed oxide core may contain zirconium oxide, cerium oxide, lanthanum oxide, yttrium oxide, and optionally neodymium oxide, and the rare earth of the rare earth oxide coating may be cerium or neodymium. In this embodiment, the mixed oxide core of the composition may have a ratio of Ce/Zr/La/Nd/Y of approximately 36.5 wt % to approximately 41.5 wt % Ce, approximately 50 wt % to approximately 53 wt % Zr, approximately 3.5 wt % to approximately 5.5 wt % La, approximately 0 wt % to approximately 1.5 wt % Nd, and approximately 1.8 wt % to approximately 5.6 wt % Y, on an equivalent oxide basis, and the rare earth oxide coating consists essentially of CeO₂ or Nd₂O₃. In certain of these embodiments, the rare earth oxide coating is about 3 wt % to about 6 wt % based on the total weight of the composition.

All of the above-described compositions are free of alumina. All of the above-described compositions may be combined with the above-described rhodium or palladium dispersion percentages after aging.

The compositions as disclosed herein may be used as part of a catalyst system or incorporated into a catalyst composition. These catalysts may be used in gas exhaust purification. The higher rhodium or palladium dispersion makes these compositions particularly suitable for use in catalysis as part of a catalyst system or as catalytic carriers. The catalysts are used in vehicles to purify exhaust gases, and for other related uses.

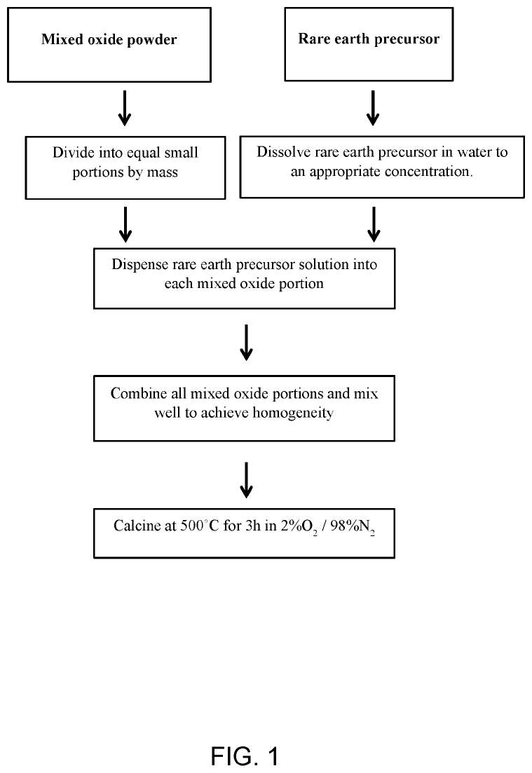

Further disclosed herein are processes of producing these compositions comprising a mixed oxide core having a rare earth oxide coating on its surface, and the composition having rhodium or palladium on the surface. These compositions having a higher rhodium or palladium dispersion as disclosed herein are made by processes providing the mixed oxide core having a rare earth oxide coating and provides for higher rhodium or palladium dispersion. FIG. 1 is a flow chart for an embodiment of a process of making these compositions having higher rhodium or palladium dispersion.

The process includes steps of: (a) providing mixed oxide powders of cerium oxide, zirconium oxide, and optionally one or more of rare earth oxides selected from the group consisting of neodymium, lanthanum, praseodymium, and yttrium; (b) dissolving a rare earth salt in water where the rare earth of the salt is selected from the group consisting of cerium, lanthanum, neodymium, praseodymium, yttrium, and mixtures thereof to provide a rare earth solution; (c) combining the rare earth solution with the mixed oxide powders and mixing to provide a homogeneous powder mixture; (d) calcining the homogeneous powder mixture at approximately 400° C. to approximately 600° C. (preferably 500° C.) for approximately 2 hours to 5 hours (preferably 3 hours) to provide a mixed oxide core with a rare earth oxide coating on its surface, wherein the rare earth of the rare oxide coating is selected from the group consisting of cerium, lanthanum, neodymium, praseodymium, yttrium, and mixtures thereof; (c) adding a rhodium or palladium salt solution to the mixed oxide core with a rare earth oxide coating; and (f) calcining at about 500° C. to about 650° C. (preferably 550° C.) for about 2 hours to about 5 hours (preferably 2 hours) to provide a composition comprising a mixed oxide core having a rare earth oxide coating on the surface and having higher rhodium or palladium dispersion versus a composition comprising a mixed oxide core without, or not having, a rare earth oxide coating. In one embodiment, the calcining in step (d), the “first calcination”, is at a temperature of about 500° C. for approximately 3 hours. In one embodiment, the calcining in step (f), the “second calcination”, is at a temperature of about 550° C. for about 2 hours. These two specific embodiments or step (d) and step (f) may be combined together.

The mixed oxide powders include zirconium oxide powder and cerium oxide powder, and optionally one or more of rare earth oxides powders of neodymium, lanthanum, praseodymium, and yttrium. The mixed oxide powders of step (a) can be divided into equal portions by mass, as shown in the flow chart of FIG. 1.

The rare earth salt of step (b) is any rare earth salt that is water soluble. The salts can be inorganic salts or organic acid salts. For example, the water soluble salts can be chloride, sulfate, nitrate, ammonium nitrate, acetate, and the like. In certain embodiments, the rare earth salt can be a chloride salt, a nitrate salt, or ammonium nitrate salt. The rare earth salt is dissolved in water to create a rare earth salt solution. As described herein, the rare earth of the salt may be cerium, lanthanum, praseodymium, neodymium, yttrium, or mixtures thereof. In certain embodiments, the rare earth of the salt is cerium, neodymium, praseodymium, or mixtures thereof. The rare earth salt solution may have any suitable rare earth concentration in g/L.

In certain embodiments, the rare earth salts may be cerium nitrate, ceric ammonium nitrate, neodymium nitrate, neodymium acetate, praseodymium nitrate, praseodymium acetate, or any mixtures thereof.

The rare earth solution is combined with the mixed oxide powders and mixed to provide a homogeneous mixture. If the mixed oxide powders are divided into small equal portions and individually combined with small amounts of the rare earth salt solutions, then all of the mixed oxide portions are then combined together and mixed to obtain a homogenous mixture. The rare earth salt solution provides the rare earth oxide coating on the mixed oxide core. It is also appropriate to describe as the rare earth salt solution provides the surface modification of the mixed oxide.

The homogeneous powder mixture is calcined at a temperature of about 400° C. to about 600° C. (in one embodiment at approximately 500° C.) for about 2 to 5 hours (in one embodiment approximately 3 hours) to provide a mixed oxide core with a rare earth oxide coating on the surface, wherein the rare earth of the rare earth oxide coating is selected from the group consisting of cerium, lanthanum, neodymium, praseodymium, yttrium, and mixtures thereof. As such, after calcining, the mixed oxide core has a rare earth oxide coating on its surface, wherein the rare earth of the coating is selected from the group consisting of cerium, lanthanum, neodymium, praseodymium, yttrium, and mixtures thereof. The calcining may take place in a 2% O₂ and 98% N₂ gas mixture.

After calcining, the precious metal is added to the mixed oxide core having a rare earth coating. In certain embodiments, after calcining, the rhodium or palladium is added to the mixed oxide core having a rare earth coating. Generally, the rhodium or palladium is added as a rhodium or palladium salt solution to the mixed oxide core with the rare earth oxide coating. After adding/impregnating with the rhodium or palladium, the composition is calcined at about 500° C. to about 650° C. (in one embodiment at approximately 550° C.) for about 2 hours to about 5 hours (in one embodiment approximately 2 hours) to provide a composition comprising a mixed oxide core having a rare earth oxide coating on its surface and having higher rhodium or palladium dispersion versus a composition comprising a mixed oxide core without a rare earth oxide coating.

In certain embodiments, the mixed oxide powders comprise cerium oxide, zirconium oxide, neodymium oxide, and lanthanum oxide and a rhodium salt is added in step (e). In other embodiments, the mixed oxide powders comprise cerium oxide, zirconium oxide, neodymium oxide, lanthanum oxide, and praseodymium oxide, and a palladium salt is added in step (e). In additional embodiments, the mixed oxide powders comprise cerium oxide, zirconium oxide, neodymium oxide, lanthanum oxide, and yttrium oxide, and a palladium salt is added in step (e). In further embodiments, the mixed oxide powders comprise cerium oxide, zirconium oxide, lanthanum oxide, and yttrium oxide, and a palladium salt is added in step (e).

In specific embodiments, the rhodium loading/adding is performed as follows. About 0.5 wt % Rh₂O₃ was supported by impregnation of a measured amount of rhodium nitrate solution (14.21% rhodium) onto 4.19 g of each sample (i.e., mixed oxide core having the rare earth oxide coating). The rhodium nitrate then was diluted in water to reach incipient wetness of each sample of the composition disclosed herein. The diluted rhodium nitrate solution was added dropwise over the mixed oxide powder with rare earth coating while mixing. The powder was then dried and calcined at 550° C. for 2 hours.

In specific embodiments, the palladium loading/adding is performed as follows. About 1.6 wt % PdO was supported by impregnation of a measured amount of palladium nitrate solution (17.99% palladium) onto 7.92 g of each sample (i.e., mixed oxide core having the rare earth oxide coating). The palladium nitrate was diluted in water to reach incipient wetness of each sample. The diluted palladium nitrate solution was added dropwise over the mixed oxide powder with rare earth coating while mixing. The powder was then dried and calcined at 550° C. for 2 hours.

The process as described herein provides the compositions with rhodium or palladium on the surface and having higher rhodium or palladium dispersion and having any or all of the above-described characteristics and properties.

The compositions disclosed herein may be used as part of a catalyst system or in catalyst compositions. These catalysts are used in vehicles to purify exhaust gases, and for other related uses.

In the following, Examples are given to illustrate the inventive method for the preparation of the compositions with rhodium or palladium dispersed on the surface as described herein and characterization thereof in more detail, although the scope of the invention is never limited thereby in any way.

FIG. 1 is a flow chart for an embodiment of a process of producing the compositions comprising a mixed oxide core having a rare earth oxide coating on its surface, and the composition having with rhodium or palladium on the surface with a high rhodium or palladium dispersion.

The rhodium and palladium dispersion in the examples below was measured using the processes described above for measurement of rhodium and palladium dispersion.

### Comparative Example 1: A Mixed Oxide without Further Surface Modification (without Rare Earth Oxide Coating) with Rh

### The Following was Done:

1) A mixed oxide (the composition consisting essentially of Ce/Zr/La/Nd, and in a ratio of about 20.8 wt % Ce, about 72.2 wt % Zr, about 1.7 wt % La, and about 5.3 wt % Nd was prepared without further surface modification with a rare earth coating.

The rhodium loading/adding was performed as follows. About 0.5 wt % Rh₂O₃ was supported by impregnation of a measured amount of rhodium nitrate solution onto an amount of the mixed oxide sample. The rhodium nitrate then was diluted in water to reach incipient wetness of the sample. The diluted rhodium nitrate solution was added dropwise over the mixed oxide powder while mixing. The powder was then dried and calcined at 550° C. for 2 h.

### Comparative Example 2: A Mixed Oxide without Further Surface Modification (without Rare Earth Oxide Coating) with Pd

### The Following was Done:

1) A mixed oxide, the mixed oxide composition comprising Ce/Zr/La/Nd/Pr, and in a ratio of about 40 wt % Ce, 50 wt % Zr, 2 wt % La, 4 wt % Nd, and 4 wt % Pr was prepared without further surface modification with a rare earth coating.

The pallidum loading/adding was performed as follows. About 1.6 wt % PdO was supported by impregnation of a measured amount of palladium nitrate solution onto and amount of the mixed oxide sample. The palladium nitrate then was diluted in water to reach incipient wetness of each sample of the composition disclosed herein. The diluted palladium nitrate solution was added dropwise over the mixed oxide powders while mixing. The powder was then dried and calcined at 550° C. for 2 h.

### Example 1: Mixed Oxide with Nd₂O₃ Coating (Nd₂O₃ Surface Modified Mixed Oxide) with Rh

### The Following was Done:

1) 12.25 g of a mixed oxide (the composition comprising Ce/Zr/La/Nd, and in a ratio of about 21.4 wt % Ce, about 74.4 Wt % Zr, about 1.8 wt % La, and about 2.4 wt % Nd) was divided into equal portions.
2) 1.73 g of Nd nitrate solution (Nd₂O₃=306.0 g/L, density=1.47 g/mL) was combined with 3.8 mL of DI water.
3) The diluted Nd nitrate solution was slowly added into each mixed oxide portion.
4) All portions were combined and mixed to produce a homogenous mixture.
5) The powder was calcined at 500° C. to produce an oxide support.

The rhodium loading/adding was performed as follows. About 0.5 wt % Rh₂O₃ was supported by impregnation of a measured amount of rhodium nitrate solution (14.21% rhodium) onto 4.19 g of the mixed oxide with rare earth coating sample. The rhodium nitrate then was diluted in water to reach incipient wetness of the sample. The diluted rhodium nitrate solution was added dropwise over the mixed oxide powder with rare earth coating while mixing. The powder was then dried and calcined at 550° C. for 2 h.

### Example 2: Mixed Oxide with Nd₂O₃ and CeO₂ Coating (Nd₂O₃ and CeO₂ Surface Modified Mixed Oxide) with Rh

### The Following was Done:

1) 1.15 g of ceric ammonium nitrate (CAN) and 1.75 g of Nd nitrate solution (Nd₂O₃=297.9 g/L, density=1.45 g/mL) was combined with 2.9 mL of DI water.
2) The Ce/Nd solution was added to 11.88 g of CZO (the composition comprising Ce/Zr/La/Nd, and in a ratio of about 18.93 wt % Ce, about 76.81 wt % Zr, about 1.81 wt % La, and about 2.45 wt % Nd) to obtain a homogenous mixture.
3) The powder was calcined at 500° C. to produce an oxide support.

The rhodium loading/adding was performed as follows. About 0.5 wt % Rh₂O₃ was supported by impregnation of a measured amount of rhodium nitrate solution (14.21% rhodium) onto 4.19 g of the mixed oxide with rare earth coating sample. The rhodium nitrate then was diluted in water to reach incipient wetness of the sample. The diluted rhodium nitrate solution was added dropwise over the mixed oxide powder with rare earth coating while mixing. The powder was then dried and calcined at 550° C. for 2 h.

### Summary of Comparative Example 1 and Examples 1 and 2

The following Table 1 summarizes the mixed oxide compositions before any surface modification (i.e., before adding the rare earth oxide coating). Comparative Example 1 has no surface modification (i.e., rare earth oxide coating).

TABLE 1
Mixed Oxide Compositions for Comparative
Example 1 and Examples 1 and 2

| | CeO₂ | ZrO₂ | La₂O₃ | Nd₂O₃ |
|---|---|---|---|---|
| Comparative Ex. 1 | 20.8 | 72.2 | 1.7 | 5.3 |
| Ex. 1 | 21.44 | 74.44 | 1.75 | 2.37 |
| Ex. 2 | 18.93 | 76.81 | 1.81 | 2.45 |

The following Table 2 summarizes the mixed oxide compositions of Comparative Example 1 and Examples 1 and 2 after surface modification (i.e., after adding the rare earth oxide coating).

TABLE 2
Mixed Oxide Compositions for Comparative Example
1 and Examples 1 and 2 After Surface Modification

| | RE Coating | CeO₂ | ZrO₂ | La₂O₃ | Nd₂O₃ |
|---|---|---|---|---|---|
| Comparative Ex. 1 | None | 20.8 | 72.2 | 1.7 | 5.3 |
| Ex. 1 | 3 wt % Nd₂O₃ | 20.8 | 72.2 | 1.7 | 5.3 |
| Ex. 2 | 3 wt % Nd₂O₃ | 20.8 | 72.2 | 1.7 | 5.3 |
| | 3 wt % CeO₂ | | | | |

The following Table 3 summarizes the rhodium dispersion results for Comparative Example 1 and Examples 1 and 2 with surface modification (i.e., rare earth oxide coating).

TABLE 3
Rhodium Dispersion Results for Comparative
Example 1 and Examples 1 and 2

| | Air aged | Air aged | Air aged |
|---|---|---|---|
| | 800° C./2 hrs | 1000° C./10 hrs | 1100° C./10 hrs |
| Comparative | 17.9% | 13.7% | 10.0% |
| Ex. 1 | | | |
| Ex. 1 | 20.6% | 14.6% | 10.6% |
| Ex. 2 | 19.4% | 15.7% | 10.3% |

As summarized in Table 3, Examples 1 and 2 exhibit significantly higher % rhodium dispersion across different aging (further calcination) conditions, when compared to Comparative Example 1. With these higher % rhodium dispersion, the present compositions provide improve catalytic material for catalytic converters and vehicles to purify gases.

### Example 3: Mixed Oxide with Nd₂O₃ Coating (Nd₂O₃ Surface Modified Mixed Oxide) with Pd

### The Following was Done:

1) 0.389 g of Nd nitrate solution (Nd₂O₃=297.9 g/L, density=1.45 g/mL) was combined with 4.2 mL of DI water.
2) The Nd solution was added to 7.92 g of CZO (the composition comprising Ce/Zr/La/Nd/Pr, and in a ratio of about 40.40 wt % Ce, about 50.51 wt % Zr, about 2.02 wt % La, about 3.03 wt % Nd, and about 4.04 wt % Pr) to obtain a
3) The powder was calcined at 500° C. to produce an oxide support.

The palladium loaded/added as follows. About 1.6 wt % PdO was supported by impregnation of a measured amount of palladium nitrate solution (17.99% palladium) onto 7.92 g of the mixed oxide sample. The palladium nitrate then was diluted in water to reach incipient wetness of the sample. The diluted palladium nitrate solution was added dropwise over the mixed oxide powders while mixing. The powder was then dried and calcined at 550° C. for 2 h.

### Example 4: Mixed Oxide with Nd₂O₃ Coating (Nd₂O₃ Surface Modified Mixed Oxide) with Pd

### The Following was Done:

1) 0.779 g of Nd nitrate solution (Nd₂O₃=297.9 g/L, density=1.45 g/mL) was combined with 3.0 mL of DI water.
2) The Nd solution was added to 7.84 g of CZO (the composition comprising Ce/Zr/La/Nd/Pr, and in a ratio of about 40.82 wt % Ce, about 51.02 wt % Zr, about 2.04 wt % La, about 2.04 wt % Nd, and about 4.08 wt % Pr) to obtain a homogenous mixture.
3) The powder was calcined at 500° C. to produce an oxide support.

The palladium loaded/added as follows. About 1.6 wt % PdO was supported by impregnation of a measured amount of palladium nitrate solution (17.99% palladium) onto 7.92 g of the mixed oxide sample. The palladium nitrate then was diluted in water to reach incipient wetness of the sample. The diluted palladium nitrate solution was added dropwise over the mixed oxide powders while mixing. The powder was then dried and calcined at 550° C. for 2 h.

### Example 5: Mixed Oxide with Nd₂O₃ Coating (Nd₂O₃ Surface Modified Mixed Oxide) with Pd

### The Following was Done:

1) 1.168 g of Nd nitrate solution (Nd₂O₃=297.9 g/L, density=1.45 g/mL) was combined with 3.8 mL of DI water.
2) The Nd solution was added to 7.76 g of CZO (the composition comprising Ce/Zr/La/Nd/Pr, and in a ratio of about 41.24 wt % Ce, about 51.55 wt % Zr, about 2.06 wt % La, about 1.03 wt % Nd, and about 4.12 wt % Pr) to obtain a
3) The powder was calcined at 500° C. to produce an oxide support.

The palladium loaded/added as follows. About 1.6 wt % PdO was supported by impregnation of a measured amount of palladium nitrate solution (17.99% palladium) onto 7.92 g of the mixed oxide sample. The palladium nitrate then was diluted in water to reach incipient wetness of the sample. The diluted palladium nitrate solution was added dropwise over the mixed oxide powders while mixing. The powder was then dried and calcined at 550° C. for 2 h.

### Example 6: Mixed Oxide with Pr₆O₁₁ Coating (Pr₆O₁₁ Surface Modified Mixed Oxide) with Pd

### The Following was Done:

1) 0.562 g of Pr nitrate solution (Pr₆O₁₁=313.85 g/L, density=1.47 g/mL) was combined with 6.5 mL of DI water.
2) The Pr solution was added to 11.88 g of CZO (the composition comprising Ce/Zr/La/Nd/Pr, and in a ratio of about 40.40 wt % Ce, about 50.51 wt % Zr, about 2.02 wt % La, about 4.04 wt % Nd, and about 3.03 wt % Pr) to obtain a homogenous mixture.
3) The powder was calcined at 500° C. to produce an oxide support.

The palladium loaded/added as follows. About 1.6 wt % PdO was supported by impregnation of a measured amount of palladium nitrate solution (17.99% palladium) onto 7.92 g of the mixed oxide sample. The palladium nitrate then was diluted in water to reach incipient wetness of the sample. The diluted palladium nitrate solution was added dropwise over the mixed oxide powders while mixing. The powder was then dried and calcined at 550° C. for 2 h.

### Example 7: Mixed Oxide with Pr₆O₁₁ Coating (Pr₆O₁₁ Surface Modified Mixed Oxide) with Pd

### The Following was Done:

1) 1.124 g of Pr nitrate solution (Pr₆O₁₁=313.85 g/L, density=1.47 g/mL) was combined with 4.6 mL of DI water.
2) The Pr solution was added to 11.76 g of CZO (the composition comprising Ce/Zr/La/Nd/Pr, and in a ratio of about 40.82 wt % Ce, about 51.02 wt % Zr, about 2.04 wt % La, about 4.08 wt % Nd, and about 2.04 wt % Pr) to obtain a
3) The powder was calcined at 500° C. to produce an oxide support.

The palladium loaded/added as follows. About 1.6 wt % PdO was supported by impregnation of a measured amount of palladium nitrate solution (17.99% palladium) onto 7.92 g of the mixed oxide sample. The palladium nitrate then was diluted in water to reach incipient wetness of the sample. The diluted palladium nitrate solution was added dropwise over the mixed oxide powders while mixing. The powder was then dried and calcined at 550° C. for 2 h.

### Example 8: Mixed Oxide with Pr₆O₁₁ Coating (Pr₆O₁₁ Surface Modified Mixed Oxide) with Pd

### The Following was Done:

1) 1.686 g of Pr nitrate solution (Pr₆O₁₁=313.85 g/L, density=1.47 g/mL) was combined with 5.6 mL of DI water.
2) The Pr solution was added to 11.64 g of CZO (the composition comprising Ce/Zr/La/Nd/Pr, and in a ratio of about 41.24 wt % Ce, about 51.55 wt % Zr, about 2.06 wt % La, about 4.12 wt % Nd, and about 1.03 wt % Pr) to obtain a homogenous mixture.
3) The powder was calcined at 500° C. to produce an oxide support.

The palladium loaded/added as follows. About 1.6 wt % PdO was supported by impregnation of a measured amount of palladium nitrate solution (17.99% palladium) onto 7.92 g of the mixed oxide sample. The palladium nitrate then was diluted in water to reach incipient wetness of the sample. The diluted palladium nitrate solution was added dropwise over the mixed oxide powders while mixing. The powder was then dried and calcined at 550° C. for 2 h.

### Example 9: Mixed Oxide with CeO₂ Coating (CeO₂ Surface Modified Mixed Oxide) with Pd

### The Following was Done:

1) 1.60 g of ceric ammonium nitrate (CAN) was combined with 5.9 mL of DI water.
2) The Ce solution was added to 9.50 g of CZO (the composition comprising Ce/Zr/La/Nd/Pr, and in a ratio of about 36.84 at % Ce, about 52.63 wt % Zr, about 2.11 wt % La, about 4.21 wt % Nd, and about 4.21 wt % Pr) to obtain a
3) The powder was calcined at 500° C. to produce an oxide support.

The palladium loaded/added as follows. About 1.6 wt % PdO was supported by impregnation of a measured amount of palladium nitrate solution (17.99% palladium) onto 7.92 g of the mixed oxide sample. The palladium nitrate then was diluted in water to reach incipient wetness of the sample. The diluted palladium nitrate solution was added dropwise over the mixed oxide powders while mixing. The powder was then dried and calcined at 550° C. for 2 h.

### Summary of Comparative Example 2 and Examples 3-9

The following Table 4 summarizes the mixed oxide compositions before any surface modification (i.e., before adding the rare earth oxide coating). Comparative Example 2 has no surface modification (i.e., rare earth oxide coating).

TABLE 4
Mixed Oxide Compositions for Comparative
Example 2 and Examples 3-9

| | CeO₂ | ZrO₂ | La₂O₃ | Nd₂O₃ | Pr₆O₁₁ |
|---|---|---|---|---|---|
| Comparative Ex. 2 | 40 | 50 | 2 | 4 | 4 |
| Ex. 3 | 40.40 | 50.51 | 2.02 | 3.03 | 4.04 |
| Ex. 4 | 40.82 | 51.02 | 2.04 | 2.04 | 4.08 |
| Ex. 5 | 41.24 | 51.55 | 2.06 | 1.03 | 4.12 |
| Ex. 6 | 40.40 | 50.51 | 2.02 | 4.04 | 3.03 |
| Ex. 7 | 40.82 | 51.02 | 2.04 | 4.08 | 2.04 |
| Ex. 8 | 41.24 | 51.55 | 2.06 | 4.12 | 1.03 |
| Ex. 9 | 36.84 | 52.63 | 2.11 | 4.21 | 4.21 |

The following Table 5 summarizes the mixed oxide compositions of Comparative Example 2 and Examples 3-9 after surface modification (i.e., after adding the rare earth oxide coating).

TABLE 5
Mixed Oxide Composition for Comparative Example
2 and Examples 3-9 After Surface Modification

| | RE coating | CeO₂ | ZrO₂ | La₂O₃ | Nd₂O₃ | Pr₆O₁₁ |
|---|---|---|---|---|---|---|
| Comparative | None | 40 | 50 | 2 | 4 | 4 |
| Ex. 2 | | | | | | |
| Ex. 3 | 1 wt % Nd₂O₃ | 40 | 50 | 2 | 4 | 4 |
| Ex. 4 | 2 wt % Nd₂O₃ | 40 | 50 | 2 | 4 | 4 |
| Ex. 5 | 3 wt % Nd₂O₃ | 40 | 50 | 2 | 4 | 4 |
| Ex. 6 | 1 wt % Pr₆O₁₁ | 40 | 50 | 2 | 4 | 4 |
| Ex. 7 | 2 wt % Pr₆O₁₁ | 40 | 50 | 2 | 4 | 4 |
| Ex. 8 | 3 wt % Pr₆O₁₁ | 40 | 50 | 2 | 4 | 4 |
| Ex. 9 | 5 wt % CeO₂ | 40 | 50 | 2 | 4 | 4 |

The following Table 6 summarizes the palladium dispersion results for Comparative Example 3 and Examples 3-9 with surface modification (i.e., rare earth oxide coating).

TABLE 6
Palladium Dispersion Results for Comparative
Example 2 and Examples 3-9

| | Air aged | Air aged | Air aged |
|---|---|---|---|
| | 800° C./2 hrs | 1000° C./10 hrs | 1100° C./10 hrs |
| Comparative | 28.8% | 7.7% | 3.6% |
| Ex. 2 | | | |
| Ex. 3 | 40.9% | 9.9% | 4.2% |
| Ex. 4 | 40.1% | 9.3% | 4.4% |
| Ex. 5 | 41.0% | 9.1% | 4.3% |
| Ex. 6 | 38.8% | 8.5% | 4.0% |
| Ex. 7 | 36.8% | 9.2% | 4.1% |
| Ex. 8 | 39.1% | 8.7% | 3.9% |
| Ex. 9 | 36.9% | 9.6% | 3.9% |

As summarized in Table 6, Examples 3-9 exhibit significantly higher % palladium dispersion across different aging (further calcination) conditions, when compared to Comparative Example 2. With these higher % palladium dispersion, the present compositions provide improve catalytic material for catalytic converters and vehicles to purify gases.

### Example 10: Mixed Oxide with CeO₂ Coating (CeO₂ Surface Modified Mixed Oxide) with Pd

### The Following was Done:

1) 2.40 g of ceric ammonium nitrate (CAN) was combined with 8.5 mL of DI water.
2) The Ce solution was added to 14.25 g of CZO (the composition comprising Ce/Zr/La/Y, and in a ratio of about 36.84 wt % Ce, about 52.63 wt % Zr, about 5.26 wt % La, and about 5.26 wt % Y) to obtain a homogenous mixture.
3) The powder was calcined at 500° C. to produce an oxide support.

The palladium loaded/added as follows. About 1.6 wt % PdO was supported by impregnation of a measured amount of palladium nitrate solution (17.99% palladium) onto 7.92 g of the mixed oxide sample. The palladium nitrate then was diluted in water to reach incipient wetness of the sample. The diluted palladium nitrate solution was added dropwise over the mixed oxide powders while mixing. The powder was then dried and calcined at 550° C. for 2 h.

### Example 11: Mixed Oxide with Nd₂O₃ Coating (Nd₂O₃ Surface Modified Mixed Oxide) with Pd

### The Following was Done:

1) 2.34 g of Nd nitrate solution (Nd₂O₃=297.9 g/L, density=1.45 g/mL) was combined with 8.5 mL of DI water.
2) The Nd solution was added to 15.52 g of CZO (the composition comprising Ce/Zr/La/Nd/Y, and in a ratio of about 41.24 wt % Ce, about 51.55 wt % Zr, about 4.12 wt % La, about 1.03 wt % Nd, and about 2.06 wt % Y) to obtain a homogenous mixture.
3) The powder was calcined at 500° C. to produce an oxide support.

The palladium loaded/added as follows. About 1.6 wt % PdO was supported by impregnation of a measured amount of palladium nitrate solution (17.99% palladium) onto 7.92 g of the mixed oxide sample. The palladium nitrate then was diluted in water to reach incipient wetness of the sample. The diluted palladium nitrate solution was added dropwise over the mixed oxide powders while mixing. The powder was then dried and calcined at 550° C. for 2 h.

### Summary of Examples 10 and 11

The following Table 7 summarizes the mixed oxide composition before any surface modification. (i.e., before adding the rare earth oxide coating).

TABLE 7
Mixed Oxide Composition for Examples 10 and 11

| | CeO₂ | ZrO₂ | La₂O₃ | Nd₂O₃ | Y₂O₃ |
|---|---|---|---|---|---|
| Ex. 10 | 36.84 | 52.64 | 5.26 | — | 5.26 |
| Ex. 11 | 41.24 | 51.55 | 4.12 | 1.03 | 2.06 |

The following Table 8 summarizes the mixed oxide compositions of Examples 10 and 11 after surface modification (i.e., after adding the rare earth oxide coating).

TABLE 8
Mixed Oxide Composition for Examples 10 and 11

| | RE coating | CeO₂ | ZrO₂ | La₂O₃ | Nd₂O₃ | Y₂O₃ |
|---|---|---|---|---|---|---|
| Ex. 10 | 5 wt % CeO₂ | 40 | 50 | 5 | — | 5 |
| Ex. 11 | 3 wt % Nd₂O₃ | 40 | 50 | 4 | 4 | 2 |

The following Table 9 summarizes the palladium dispersion results for Examples 10 and 11 with surface modification (i.e., rare earth oxide coating).

TABLE 9
Palladium Dispersion Results for Examples 10 and 11

| | Air aged | Air aged | Air aged |
|---|---|---|---|
| | 800° C./2 hrs | 1000° C./10 hrs | 1100° C./10 hrs |
| Ex. 10 | 42.6% | 9.7% | 4.6% |
| Ex. 11 | 40.6% | 12.3% | 5.7% |

As summarized in Table 9, Examples 10 and 11 exhibit significantly higher % palladium dispersion across different aging (further calcination) conditions. With these higher % palladium dispersion, the present compositions provide improve catalytic material for catalytic converters and vehicles to purify gases.

Unless otherwise indicated, all numbers expressing quantities of ingredients, properties such as molecular weight, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained.

Notwithstanding that the numerical ranges and parameters setting forth the broad scope of the technology are approximations, the numerical values set forth in the specific examples are reported as precisely as possible. Any numerical value, however, inherently contain certain errors necessarily resulting from the standard deviation found in their respective testing measurements.

It will be clear that the compositions and methods described herein are well adapted to attain the ends and advantages mentioned as well as those inherent therein. Those skilled in the art will recognize that the methods and systems within this specification may be implemented in many manners and as such are not to be limited by the foregoing exemplified embodiments and examples. In this regard, any number of the features of the different embodiments described herein may be combined into one single embodiment and alternate embodiments having fewer than or more than all of the features herein described are possible.

While various embodiments have been described for purposes of this disclosure, various changes and modifications may be made which are well within the scope contemplated by the present disclosure. Numerous other changes may be made which will readily suggest themselves to those skilled in the art and which are encompassed in the spirit of the disclosure.

1. A composition comprising a mixed oxide core comprising about 15 wt % to about 60 wt % cerium oxide based on the total weight of the mixed oxide core and about 40 wt % to about 85 wt % zirconium oxide based on the total weight of the mixed oxide core and being free of alumina,
the mixed oxide core having a rare earth oxide coating, the rare earth of the rare earth oxide coating being selected from the group consisting of cerium, lanthanum, neodymium, praseodymium, yttrium, and mixtures thereof and the composition having rhodium or palladium on the surface, wherein the composition has a higher rhodium or palladium dispersion versus a composition with a mixed oxide core without a rare earth oxide coating.

2. A composition comprising a mixed oxide core comprising about 15 wt % to about 25 wt % cerium oxide based on the total weight of the mixed oxide core; about 70 wt % to about 85 wt % zirconium oxide based on the total weight of the mixed oxide core;
optionally one or more of lanthanum oxide, neodymium oxide, praseodymium oxide, and yttrium oxide; and being free of alumina,
the mixed oxide core having a rare earth oxide coating, the rare earth of the rare earth oxide coating being selected from the group consisting of cerium, lanthanum, neodymium, praseodymium, yttrium, and mixtures thereof, and the composition having rhodium dispersed on the surface,
wherein the rhodium dispersion is about 18.5% to about 28.6% after calcination at 800° C. in air for 2 hours, or about 14.3% to about 21.9% after calcination at 1000° C. in air for 10 hours, or about 10.3% to about 16.5% after calcination at 1100° C. in air for 10 hours.

3. A composition comprising a mixed oxide core comprising about 35 wt % to about 60 wt % cerium oxide based on the total weight of the mixed oxide core; about 40 wt % to about 65 wt % zirconium oxide based on the total weight of the mixed oxide core;
optionally one or more of lanthanum oxide, neodymium oxide, praseodymium oxide, and yttrium oxide, and being free of alumina,
the mixed oxide core having a rare earth oxide coating, the rare earth of the rare earth oxide coating being selected from the group consisting of cerium, lanthanum, neodymium, praseodymium, yttrium, and mixtures thereof; and the composition having palladium dispersed on the surface,
wherein the palladium dispersion is about 35.0% to about 46.1% after calcination at 800° C. in air for 2 hours, or about 8.5% to about 13.0% after calcination at 1000° C. in air for 10 hours, or about 3.9% to about 6.0% after calcination at 1100° C. in air for 10 hours.

4. The composition of claim 1, wherein the mixed oxide core comprises about 15 wt % to about 25 wt % cerium oxide, about 70 wt % to about 85 wt % zirconium oxide, and one or more of lanthanum oxide, neodymium oxide, praseodymium oxide, and yttrium oxide; the composition having rhodium on the surface and having higher rhodium dispersion versus a composition with a mixed oxide core without a rare earth oxide coating.

5. The composition of claim 1, wherein the mixed oxide core comprises about 35 wt % to about 60 wt % cerium oxide, about 40 wt % to about 65 wt % zirconium oxide, and one or more of lanthanum oxide, neodymium oxide, praseodymium oxide, and yttrium oxide; the composition having palladium on the surface and having higher palladium dispersion versus a composition with a mixed oxide core without a rare earth oxide coating.

6. The composition of claim 4, having rhodium dispersed on the surface, wherein the rhodium dispersion is about 18.5% to about 28.6% after calcination at 800° C. in air for 2 hours, or about 14.3% to about 21.9% after calcination at 1000° C. in air for 10 hours, or about 10.3% to about 16.5% after calcination at 1100° C. in air for 10 hours.

7. The composition of claim 5, having palladium dispersed on the surface, wherein the palladium dispersion is about 35.0% to about 46.1% after calcination at 800° C. in air for 2 hours, or about 8.5% to about 13.0% after calcination at 1000° C. in air for 10 hours, or about 3.9% to about 6.0% after calcination at 1100° C. in air for 10 hours.

8. The composition of claim 1, wherein the composition comprises a mixed oxide core consisting essentially of cerium oxide, zirconium oxide, and additional rare earth oxide selected from the group consisting of lanthanum oxide, neodymium oxide, praseodymium oxide, yttrium oxide, and mixtures thereof;
the rare earth oxide coating is one or two of cerium oxide, neodymium oxide, and praseodymium oxide;
when having palladium, the palladium dispersion is about 35.0% to about 46.1% after calcination at 800° C. in air for 2 hours, or about 8.5% to about 13.0% after calcination at 1000° C. in air for 10 hours, or about 3.9% to about 6.0% after calcination at 1100° C. in air for 10 hours; or
when having rhodium, wherein the rhodium dispersion is about 18.5% to about 28.6% after calcination at 800° C. in air for 2 hours, or about 14.3% to about 21.9% after calcination at 1000° C. in air for 10 hours, or about 10.3% to about 16.5% after calcination at 1100° C. in air for 10 hours.

9. The composition of claim 6, wherein the mixed oxide core consists essentially of cerium oxide, zirconium oxide, lanthanum oxide, and neodymium oxide, and
the rare earth coating is one or both of cerium oxide and neodymium oxide.

10. The composition of claim 7, wherein the mixed oxide core consists essentially of cerium oxide, zirconium oxide, lanthanum oxide, neodymium oxide, and praseodymium oxide, and
the rare earth coating is cerium oxide, neodymium oxide, or praseodymium oxide.

11. The composition of claim 7, wherein the mixed oxide core consists essentially of cerium oxide, zirconium oxide, lanthanum oxide, neodymium oxide, and yttrium oxide, and
the rare earth coating is cerium oxide or neodymium oxide.

12. The composition of claim 7, wherein the mixed oxide core consists essentially of cerium oxide, zirconium oxide, lanthanum oxide, and yttrium oxide, and
the rare earth coating is cerium oxide or neodymium oxide.

13. The oxide composition of claim 1, wherein the composition comprises about 20 wt % to about 25 wt % cerium oxide based on the total weight of the composition and about 1 wt % to about 10 wt % rare earth oxide coating based on the total weight of the composition; and having rhodium on the surface.

14. The composition of claim 1, wherein the composition comprises about 40 wt % to about 60 wt % cerium oxide based on the total weight of the composition and about 1 wt % to about 10 wt % rare earth oxide coating based on the total weight of the composition; and
having palladium on the surface.

15. The composition of claim 1, wherein the rare earth oxide coating is about 1 wt % to about 10 wt % based on the total weight of the composition.

16. The composition of claim 15, wherein the rare earth oxide coating is a single rare earth oxide with the rare earth selected from the group consisting of cerium, lanthanum, neodymium, and praseodymium, and the rare earth oxide coating is about 1 wt % to about 5 wt % based on the total weight of the composition.

17. The composition of claim 15, wherein the rare earth oxide coating is two rare earth oxides with the rare earth selected from the group consisting of cerium, lanthanum, neodymium, and praseodymium, and each rare earth oxide in the coating being present in an amount of about 1 wt % to about 5 wt % based on the total weight of the composition.

18. The composition of claim 1, wherein the mixed oxide core comprises CeO₂ and ZrO₂ and one or more of La₂O₃, Y₂O₃, Nd₂O₃, and Pr₆O₁₁, and the rare earth oxide coating is one or two of CeO₂, Nd₂O₃, and Pr₆O₁₁.

19. The composition of claim 1, wherein the rhodium or palladium is present as oxides and the composition comprises about 0.5 wt % Rh₂O₃ or about 1.6 wt % PdO based on the total weight of the composition.

20. A catalyst composition comprising the composition of claim 1.

21. A process of producing a composition, the process comprising the steps of:
(a) providing mixed oxide powders of cerium oxide, zirconium oxide, and optionally one or more of rare earth oxides selected from the group consisting of neodymium, lanthanum, praseodymium, and yttrium;
(b) dissolving a rare earth salt in water wherein the rare earth of the salt is selected from the group consisting of cerium, lanthanum, neodymium, praseodymium, yttrium, and mixtures thereof to provide a rare earth solution;
(c) combining the rare earth solution with the mixed oxide powders and mixing to provide a homogeneous powder mixture;
(d) calcining the homogeneous powder mixture at about 400° C. to about 600° C. for about 2 to about 5 hours to provide a mixed oxide core with a rare earth oxide coating on its surface, wherein the rare earth of the coating is selected from the group consisting of cerium, lanthanum, neodymium, praseodymium, yttrium, and mixtures thereof;
(e) adding a rhodium or palladium salt solution to the mixed oxide core with a rare earth oxide coating; and
(f) calcining at about 500° C. to about 650° C. for about 2 hours to about 5 hours to provide a composition comprising a mixed oxide core having a rare earth oxide coating on the surface and having higher rhodium or palladium dispersion versus a composition comprising a mixed oxide core without a rare earth oxide coating.

22. The process of claim 21, wherein the rare earth salt of step (b) is a Ce salt, Nd salt, Pr salt, or mixtures thereof and the rare earth oxide coating is cerium oxide, neodymium oxide, praseodymium oxide, or a combination thereof.

23. The process of claim 22, wherein the salts are nitrates.

24. The process of claim 21, wherein:
the mixed oxide powders comprise cerium oxide, zirconium oxide, neodymium oxide, and lanthanum oxide and a rhodium salt is added in step (e); or
the mixed oxide powders comprise cerium oxide, zirconium oxide, neodymium oxide, lanthanum oxide, and praseodymium oxide, and a palladium salt is added in step (e); or
the mixed oxide powders comprise cerium oxide, zirconium oxide, neodymium oxide, lanthanum oxide, and yttrium oxide, and a palladium salt is added in step (e); or
the mixed oxide powders comprise cerium oxide, zirconium oxide, lanthanum oxide, and yttrium oxide, and a palladium salt is added in step (e)

25. The process of claim 21, wherein the calcining of step (d) is in a 2% O₂ and 98% N₂ gas mixture.

26. A composition made by the process of claim 21.

27. A catalyst composition comprising the composition of claim 26.
